(19) United States
(12) Patent Application Publication
(10) Pub. No.: US 2005/0248371 A1
(43) Pub. Date: Nov. 10, 2005

(54) Current to voltage amplifier

(76) Inventor: Hack-Soo Oh, Chungcheongbuk-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/083,260

(22) Filed: Mar. 16, 2005

(30) Foreign Application Priority Data
May 6, 2004 (KR) 2004-31929

(51) Int. Cl. H02M 11/00

(52) U.S. Cl. 327/103

(57) ABSTRACT

A current to voltage amplifier in accordance with the present invention includes a current to voltage amplifier for receiving a sensor input to thereby output an amplified voltage corresponding to the sensor input including a bias current provider for providing a bias current, an input block for flowing a sensor current based on the sensor input, a first diode-connected MOS transistor for receiving the bias current from the bias current provider and providing the sensor current to the input block, and a first MOS transistor for flowing a remnant current subtracting the sensor current from the bias current, wherein the amplified voltage is corresponded to the current.

### FIELD OF INVENTION

The present invention relates to a current to voltage amplifier; and, more particularly, to the current to voltage amplifier which amplifies a minute current to thereby generate an amplified voltage corresponding to the minute by using a weak-inversion characteristic of metal oxide semiconductor transistor (MOS transistor).

### DESCRIPTION OF PRIOR ART

Generally, a current sensed by a bio-sensor in a bio-chip is measured as little as several nano-amperes (nA) Since it is very difficult to use a minute current sensed by the bio-sensor directly as a control signal in a conventional integrated circuit, the minute current is amplified and converted to a corresponding voltage for generating a predetermined digital signal. Herein, a current to voltage amplifier is used for amplifying and converting the minute current to the corresponding as a bio-signal voltage.

Usually, a conventional current to voltage amplifier including operational amplifiers and resistors is used. However, a resistance of the resistors included in the current to voltage amplifier must be a relatively high value in order to obtain a predetermined level of the amplified voltage outputted from the bio-sensor.

A high resistor having a high resistance occupies very large area in an integrated circuit. Further, the current to voltage amplifier using the operational amplifiers and the high resistors consumes a large quantity of power because of the characteristics of the operational amplifier and the high resistor.

Accordingly, a current to voltage amplifier having switches and capacitors except for the high resistor is introduced for bio-chips. However, if a capacity of the capacitors used in the current to voltage amplifier is small, a relatively large noise as compared with a very small bio-signal level is generated. Because of the noise, it is hard to achieve a good performance of the current to voltage amplifier.

In order to prevent the noise for decreasing a signal to noise of ratio (SNR), the current to voltage amplifier is implemented with capacitors having large capacity. However, like the high resistor, the capacitor with large capacity occupies very large area in an integrated circuit.

As a result, the current to voltage amplifier with switches and capacitors occupies relatively large area in bio-chips and are inefficient in aspect of size.

### SUMMARY OF INVENTION

It is, therefore, an object of the present invention to provide a current to voltage amplifier that amplifies a minute current to thereby generate an amplified voltage corresponding to the minute current by using a weak inversion characteristic of a MOS transistor.

In accordance with an aspect of the present invention, there is provided a current to voltage amplifier for receiving a sensor input to thereby output an amplified voltage corresponding to the sensor input including a bias current provider for providing a bias current, an input block for flowing a sensor current based on the sensor input, a first diode-connected MOS transistor for receiving the bias current from the bias current provider and providing the sensor current to the input block, and a first MOS transistor for flowing a remnant current subtracting the sensor current from the bias current.

In accordance with another aspect of the present invention, there is provided a current to voltage amplifier for converting and amplifying a sensor current to an output voltage including a bias block for supplying a bias current and a diode-connected MOS transistor operated in a weak inversion range by flowing the sensor current for outputting the output voltage in response to voltages applied to a remnant current subtracting the sensor current from the bias current.

### BRIEF DESCRIPTION OF THE DRAWINGS

The above and other objects and features of the present invention will become apparent from the following description of preferred embodiments taken in conjunction with the accompanying drawings, in which:

FIG. 1 is a schematic circuit diagram showing a current to voltage amplifier in accordance with a preferred embodiment of the present invention;

FIG. 2A is a cross-sectional view showing an N-type MOS transistor in accordance with the present invention;

FIG. 2B is a diagram showing energy bands and charges of the N-type MOS transistor in accordance with the present invention;

FIG. 3 is a plot showing a drain current flowing between a source and a drain versus a gate voltage between a gate and a source of a diode-connected n-channel MOS transistor in saturation range in accordance with the present invention;

FIG. 4 is a plot showing the sensor current in response to the output voltage, the voltage between a gate and a source of the first MOS transistor, and the voltage between a gate and a source of the second MOS transistor in accordance with the present invention; and

FIG. 5 is a schematic circuit diagram showing a current to voltage amplifier in accordance with another preferred embodiment of the present invention.

### DETAILED DESCRIPTION OF INVENTION

Hereinafter, a current to voltage amplifier in accordance with the present invention will be described in detail referring to the accompanying drawings.

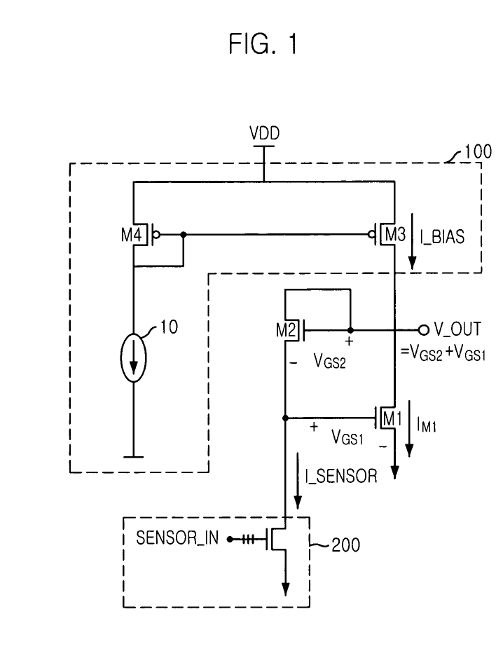

FIG. 1 is a schematic circuit diagram showing a current to voltage amplifier in accordance with a preferred embodiment of the present invention.

Referring to FIG. 1, the current to voltage amplifier in accordance with the present invention includes a bias current provider 100 for providing a bias current I_BIAS.

Also, the current to voltage amplifier includes an input block 200 for flowing a sensor current I_SENSOR in response to a sensor input SENSOR_I. Herein, the sensor current I_SENSOR is converted to an output voltage V_OUT by the current to voltage amplifier.

Further, a first MOS transistor M1 and a diode-connected second MOS transistor M2 are included in the current to voltage amplifier in accordance with the present invention. The first MOS transistor M1 is for flowing a remnant current IM1 which has a value of I_BIAS-I_SENSOR. The second MOS transistor M2 is for receiving the bias current I_BIAS from the bias current provider 100 and providing the sensor current I_SENSOR to the input block 200.

Herein, the input block 200 plays a role of an analog sensor for flowing the sensor current I_SENSOR in response to the sensor input SENSOR_IN such as bio-signal.

The current to voltage amplifier in accordance with the present invention outputs the output voltage V_OUT with holding an amount of the sensor current I_SENSOR which makes the second MOS transistor M2 operate in weak inversion range.

Further, the bias current provider 100 includes a current source 10 for producing a current, a diode-connected fourth MOS transistor M4 and a third MOS transistor M3. The fourth MOS transistor M4 let the current produced by current source 10 flow through a source and a drain. The third MOS transistor M3 forms a current mirror by using a gate connected to a gate of the fourth MOS transistor M4 and provides the bias current I_BIAS.

Herein, the first MOS transistor M1 and the second MOS transistor M2 are N-type MOS transistors, and the third MOS transistor M3 and the fourth MOS transistor M4 are P-type MOS transistors.

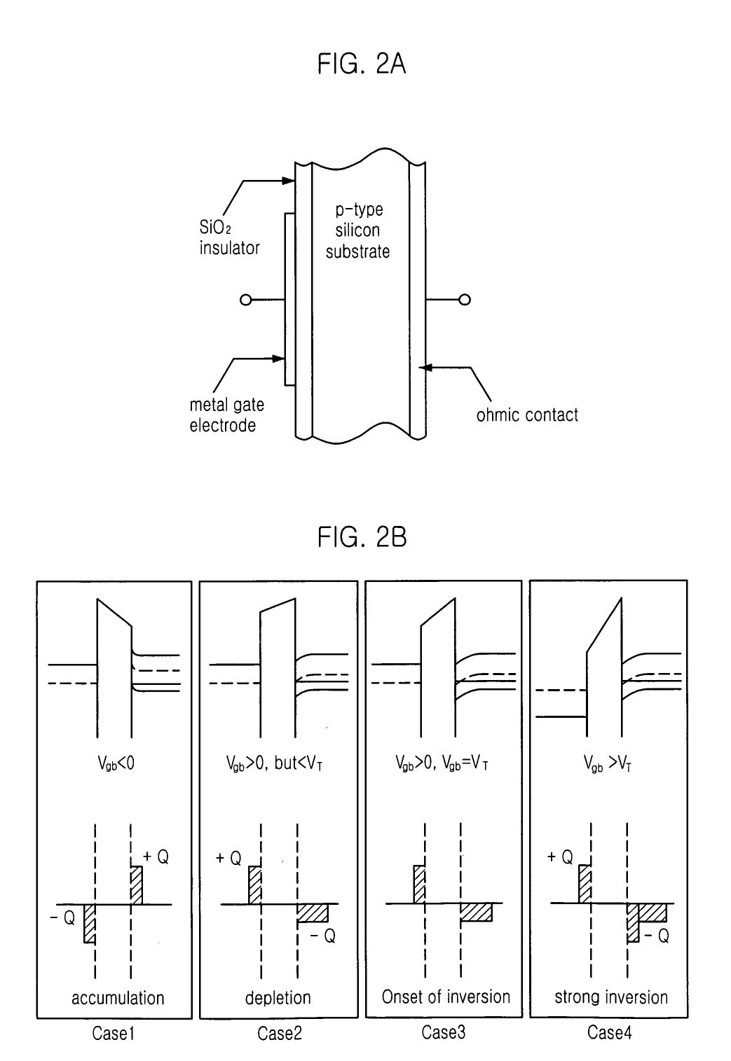

FIG. 2A is a cross-sectional view showing a N-type MOS transistor in accordance with the present invention, and FIG. 2B is a diagram showing energy bands and charges of the N-type MOS transistor in accordance with the present invention.

Referring to FIG. 2A, the N-type MOS transistor is implemented in stacked structure of a metal gate electrode/ a SiO₂ insulator/ a P-type silicon substrate/ an ohmic contact.

Referring to FIG. 2B, if the negative voltage is applied between the metal gate electrode and the P-type silicon substrate, the negative charge on the metal gate electrode attracts holes in the P-type substrate and the holes gather into a side near the SiO₂ insulator. The phenomenon above described is called as an accumulation, and case 1 of FIG. 2B shows an energy band and a charge diagram when the MOS transistor is based to the accumulation.

If a positive voltage is applied between the metal gate electrode and the P-type silicon substrate, the positive charge on the metal gate electrode pushes the mobile holes into the P-type silicon substrate. The phenomenon above described is called as a depletion, and case 2 of FIG. 2B shows an energy band and a charge diagram for the depletion.

If a more positive voltage is applied between the metal gate electrode and the P-type silicon substrate, then a part of the P-type silicon substrate near the SiO₂ insulator is changed to N-type silicon substrate. The phenomenon above described is called as an inversion, and the voltage at the point where the change is started is called a threshold voltage V_{T}. Case 3 of FIG. 2B shows an energy band and a charge diagram at onset of the inversion.

If a more positive voltage than the threshold voltage V_{T} is applied between the metal gate electrode and the P-type silicon substrate, then more part of the P-type silicon substrate near the SiO₂ insulator is changed to N-type silicon substrate. The phenomenon above described is called as a strong inversion, and case 4 of FIG. 2B shows an energy band and a diagram charge diagram at the strong inversion.

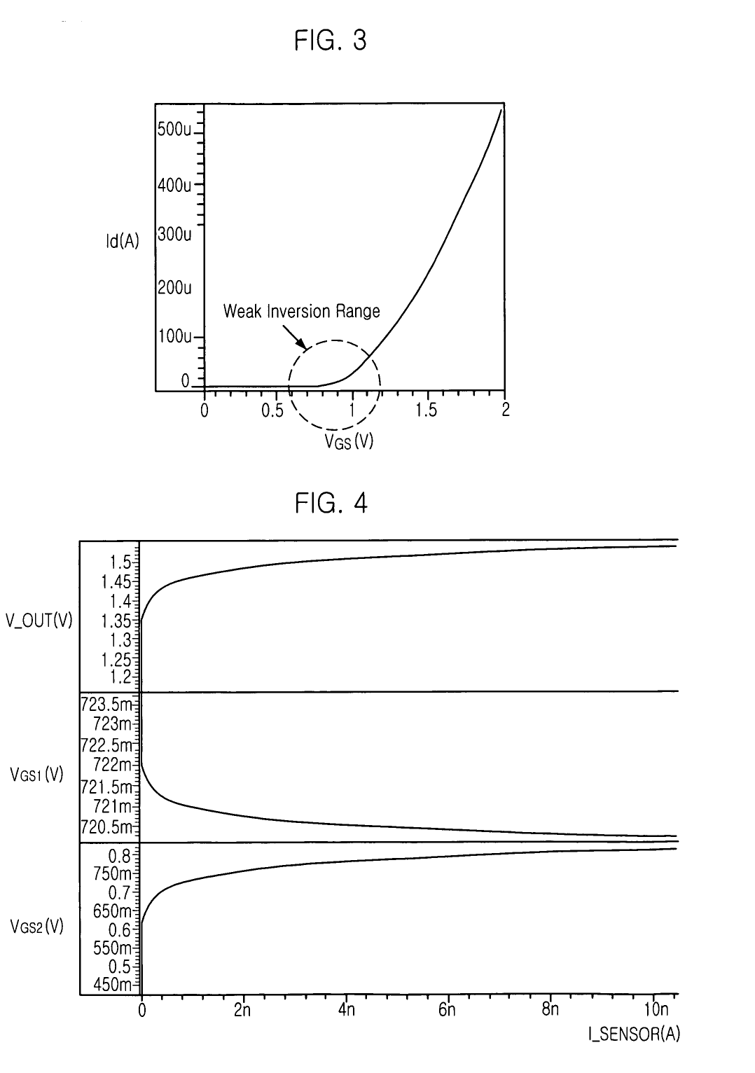

FIG. 3 is a plot showing a drain current Id flowing between a source and a drain versus a gate voltage V_{GS} between a gate and a source for diode-connected n-channel MOS transistor in saturation range in accordance with the present invention.

Where the gate voltage V_{GS} is higher than the threshold voltage V_{T} (i.e., V_{GS}≧V_{T}), the drain current Id flowing between a source and a drain increases proportionally.

Meanwhile, where the gate voltage V_{GS} is lower than the threshold voltage V_{T} (i.e., V_{GS}≦V_{T}), a small amount of the sensor current I_SENSOR flows between the source and the drain of MOS transistor. Herein, the sensor current I_SENSOR is called as a sub-threshold current. Further, the phenomenon above described is called as a weak inversion, and the weak inversion range is indicated by the circle line in FIG. 3. By using the weak inversion range, the minute current can be converted and amplified to a corresponding voltage for generating a predetermined digital signal.

In other words, when the sub-threshold current flows between the source and the drain in the MOS transistor, some amount of a gate voltage V_{GS} between the gate and the source and some amount of a drain voltage V_{DS} between the drain and the source are leaked. The present invention uses the leakage of the gate voltage V_{GS} and the drain voltage V_{DS} for converting and amplifying a current to a voltage.

Referring to FIG. 1 again, the bias current provider 100 including the third MOS transistor M3, the fourth MOS transistor M4, and the current source 10 produces the bias current I_BIAS of dozens of micro-amperes (μA). Then, the bias current provider 100 sends the bias current I_BIAS through the source and the drain of the second MOS transistor M2 and the first transistor M1.

The input block 200 makes the minute sensor current I_SENSOR of several nano-amperes (nA) flow through the source and the drain of the second MOS transistor M2 in response to the sensor input SENSOR_IN.

Accordingly, the remnant current I_{M1} having a value of I_BIAS-I_SENSOR flows between the source and the drain of the first MOS transistor M1.

The sensor current I_SENSOR flowing through the second MOS transistor M2 is very small compared with the bias current I_BIAS, that the current flowing through the gate terminal of the first MOS transistor M1 is very small. Therefore, the first MOS transistor M1 is operated in a saturation range where is V_{DS}1≧V_{GS}1−V_{T} (herein, a V_{DS}1 is a first drain voltage between the source and the drain of the first MOS transistor M1 and a V_{GS}1 is a first gate voltage between the source and the gate of the first MOS transistor M1).

Further, the second MOS transistor M2 is operated in the weak inversion range because the second MOS transistor M2 flows the minute current, i.e., the sensor current I_SENSOR.

The output voltage V_OUT has the value of V_{GS}1+V_{GS}2 (herein, V_{GS}2 is a second gate voltage between the source and the gate of the second MOS transistor M2), i.e., the minute sensor current I_SENSOR is amplified to a voltage as much as V_{GS}1+V_{GS}2.

To convert and amplify the minute sensor current I_SENSOR to the output voltage V_OUT as much as V_{GS}1+V_{GS}2 for the present invention, the second diode-connected MOS transistor M2 is operated in the weak inversion range.

Accordingly, the bias current I_BIAS is in range of about 1˜2 μA; and the sensor current I_SENSOR is in range of about 1˜10 nA, i.e., the sensor current I_SENSOR is smaller than I_BIAS/200.

FIG. 4 is a plot showing the sensor current I_SENSOR versus the output voltage V_OUT, the first gate voltage V_{GS}1 between the gate and the source of the M1, and the second gate voltage V_{GS}2 between the gate and the source of the M2 in accordance with the present invention.

Referring to FIG. 4, as the sensor current I_SENSOR changes in range from about 1 nA to about 10 nA, the first gate voltage V_{GS}1 is biased from about 723.5 mV to about 720.5 mV; and the second gate voltage V_{GS}2 is amplified from about 450 mV to about 750 mV. Further, the output voltage V_OUT is also changed from about 1.2 mV to about 1.5 mV.

As above described, the present invention makes it possible to implement the current to voltage amplifier for amplifying and converting the minute current to the corresponding voltage for generating a predetermined digital signal with a few MOS transistors, i.e., M1, M2, M3, and M4.

Therefore, the current to voltage amplifier consumes less electric power because the present invention doesn't need a large bias current I_BIAS compared with a conventional apparatus. Further, the present invention is efficient in aspect of a size of an integrated circuit because the present invention can be implemented with a few MOS transistors, i.e., M1, M2, M3, and M4. Meanwhile, the conventional current to voltage amplifier requires resistors and capacitors of large size to amplify a minute current to a corresponding voltage for generating a predetermined digital signal.

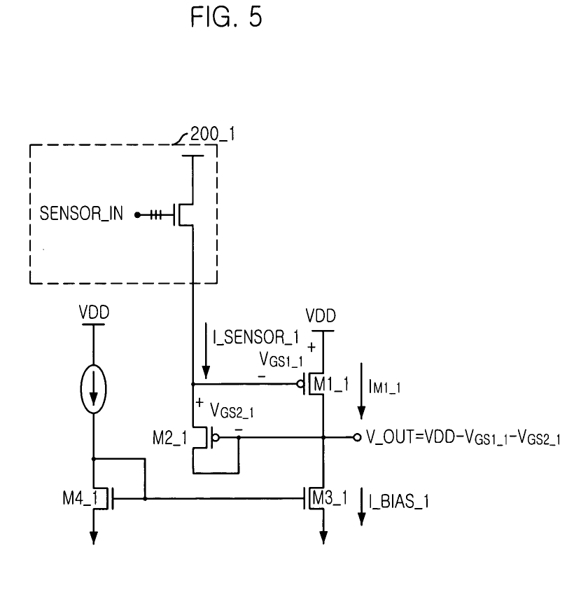

FIG. 5 is a schematic circuit diagram showing a current to voltage amplifier in accordance with another preferred embodiment of the present invention.

Herein, contrary to the current to voltage amplifier in FIG. 1, the current to voltage amplifier shown in FIG. 5 is implemented with the first P-type MOS transistor M1_1 and the second P-type MOS transistor M2_1 and the third N-type MOS transistor M3_1 and the fourth N-type MOS transistor M4_1.

Accordingly, the entire operation of the current to voltage amplifier with P-type MOS transistor shown in FIG. 5 is similar with the current to voltage amplifier with N-type MOS transistor in FIG. 1. Therefore, a detailed operation of the current to voltage amplifier shown in FIG. 5 is omitted.

The current to voltage amplifier shown in FIG. 5 uses the weak inversion characteristic of the P-type MOS transistor.

The present application contains subject matter related to Korean patent application No. 2004-31929, filed in the Korean Patent Office on May 6, 2004, the entire contents of which being incorporated herein by reference.

While the present invention has been described with respect to the particular embodiments, it will be apparent to those skilled in the art that various changes and modifications may be made without departing from the spirit and scope of the invention as defined in the following claims.

1. A current to voltage amplifier for receiving a sensor input to thereby output an amplified voltage corresponding to the sensor input, comprising:
a bias current provider for providing a bias current;
an input block for flowing a sensor current based on the sensor input;
a first diode-connected MOS transistor for receiving the bias current from the bias current provider and providing the sensor current to the input block; and
a first MOS transistor for flowing a remnant current subtracting the sensor current from the bias current, wherein the amplified voltage is corresponded to the current.

2. The current to voltage amplifier as recited in claim 1, wherein the input block is an analog sensor for flowing the sensor current in response to the sensor input which is an analog value.

3. The current to voltage amplifier as recited in claim 1, wherein the bias current provider includes:
a current source for producing a predetermined current; and
a current mirror for mirroring the predetermined current to thereby generate the bias current.

4. The current to voltage amplifier as recited in claim 3, wherein the current mirror includes a second diode-connected MOS transistor and a second MOS transistor.

5. The current to voltage amplifier as recited in claim 1, wherein the first diode-connected MOS transistor is an N-type MOS transistor.

6. The current to voltage amplifier as recited in claim 5, wherein the first MOS transistor is an N-type MOS transistor.

7. The current to voltage amplifier as recited in claim 1, wherein the first diode-connected MOS transistor is operated in a weak inversion range.

8. The current to voltage amplifier as recited in claim 7, wherein the sensor current is in range from about 1 nA to about 10 nA for operating the first diode-connected MOS transistor in the weak inversion range.

9. The current to voltage amplifier as recited in claim 8, wherein the bias current is in range from about 1 μA to about 2 μA.

10. The current to voltage amplifier as recited in claim 1, wherein the second diode-connected MOS transistor is a P-type MOS transistor.

11. The current to voltage amplifier as recited in claim 10, wherein the second MOS transistor is a P-type MOS transistor.

12. A current to voltage amplifier for converting and amplifying a sensor current to an output voltage, comprising:
a bias block for supplying a bias current; and
a diode-connected MOS transistor operated in a weak inversion range by flowing the sensor current for outputting the output voltage in response to voltages applied to a remnant current subtracting the sensor current from the bias current. 13. The current to voltage amplifier as recited in claim 12, wherein the bias block is a current mirror. 14. The current to voltage amplifier as recited in claim 13, wherein the current mirror mirrors the predetermined current to thereby generate the bias current. 15. The current to voltage amplifier as recited in claim 14, wherein the current mirror includes a second diode-connected MOS transistor and a second MOS transistor.
